(19) United States
(12) Patent Application Publication
(10) Pub. No.: US 2013/0157108 A1
(43) Pub. Date: Jun. 20, 2013

(54) LITHIUM COMPOSITE METAL OXIDE AND METHOD FOR PRODUCING SAME

(71) Applicants: Kenji Takamori, Tsukuba-shi (JP); Yuichiro Imanari, Tsukuba-shi (JP)

(72) Inventors: Kenji Takamori, Tsukuba-shi (JP); Yuichiro Imanari, Tsukuba-shi (JP)

(73) Assignee: SUMITOMO CHEMICAL COMPANY, LIMITED, Chuo-ku, Tokyo (JP)

(21) Appl. No.: 13/820,612

(22) PCT Filed: Sep. 2, 2011
(86) PCT No.: PCT/JP2011/070061

§ 371 Date: Mar. 4, 2013

(30) Foreign Application Priority Data
Sep. 6, 2010 (JP) 2010-198560

(51) Int. Cl. H01M 4/131

(52) U.S. Cl. CPC H01M 4/131
USPC 429/144; 252/182.1; 429/221

(57) ABSTRACT

The present invention provides a non-aqueous electrolyte secondary battery capable of exhibiting high discharge capacity maintenance rate at a high current rate, a lithium composite metal oxide useful therefor, and a method for producing the lithium composite metal oxide. This lithium composite metal oxide comprises Ni, Mn, Co, and Fe, and the BET specific surface area thereof is 3 m²/g to 15 m²/g. According to the present invention, a non-aqueous electrolyte secondary battery which exhibits high discharge capacity maintenance rate at a high current rate compared to a conventional lithium secondary battery can be obtained, and thus the secondary battery is very useful especially for applications where high discharge capacity maintenance rate at a high current rate is required, that is, non-aqueous electrolyte secondary batteries for automobiles or for power tools such as electric tools.

### TECHNICAL FIELD

The present invention relates to a lithium composite metal oxide and a production method thereof. More particularly, the present invention relates to a lithium composite metal oxide used in a positive electrode active material for a non-aqueous electrolyte secondary battery, and to a production method thereof.

### BACKGROUND ART

Lithium composite metal oxides are used as positive electrode active materials in non-aqueous electrolyte secondary batteries such as lithium secondary batteries. Lithium secondary batteries have already been applied practically as compact power supplies in cell phone applications, laptop personal computer applications and the like, and are attempting to be applied in medium and large-size power supply applications such as automobile or power storage applications.

A lithium composite metal oxide is specifically disclosed as an example of a lithium composite metal oxide of the prior art in Patent Document 1. This lithium composite metal oxide contains Ni, Mn, Co and Fe and is obtained by mixing lithium hydroxide, nickel hydroxide, cobalt hydroxide, dimanganese trioxide and iron hydroxide in a mortar, heat-treating each of these materials for 20 hours at 750° C. in a dry air atmosphere, and then crushing in a mortar.

### PRIOR ART DOCUMENTS

### Patent Documents

Patent Document 1: Japanese Patent No. 3281829

### SUMMARY OF THE INVENTION

### Problems to be Solved by the Invention

However, a non-aqueous electrolyte secondary battery obtained by using a conventional lithium composite metal oxide as described above as a positive electrode active material is inadequate in applications requiring a high discharge capacity maintenance rate at a high current rate, namely in automobile or power tool and other electric tool applications.

Thus, an object of the present invention is to provide a non-aqueous electrolyte secondary battery capable of demonstrating a high discharge capacity maintenance rate at a high current rate, a lithium composite metal oxide useful therefor, and a method for producing the lithium composite metal oxide.

### Means for Solving the Problems

As a result of conducting extensive studies in consideration of the aforementioned circumstances, the inventors of the present invention found that the following inventions are able to achieve the aforementioned object, thereby leading to completion of the present invention.

Namely, the present invention provides the inventions indicated below.

[1] A lithium composite metal oxide comprising Ni, Mn, Co and Fe, wherein BET specific surface area is 3 m²/g to 15 m²/g.

[2] A method for producing a lithium composite metal oxide comprising the following steps (1), (2) and (3) in that order:

(1) obtaining a co-precipitate slurry by bringing a raw material aqueous solution containing Ni ions, Mn ions, Co ions, Fe ions and sulfate ions into contact with alkali to form a co-precipitate; (2) obtaining the co-precipitate from the co-precipitate slurry; and,

(3) obtaining a lithium composite metal oxide by mixing the co-precipitate and a lithium compound, and calcining the resulting mixture by holding at a temperature of 650° C. to 950° C.

### Effects of the Invention

According to the present invention, a non-aqueous electrolyte secondary battery, that demonstrates a high discharge capacity maintenance rate at a high current rate in comparison with conventional lithium secondary batteries, can be obtained. This secondary battery is extremely useful as a non-aqueous electrolyte secondary battery particularly in applications requiring a high discharge capacity maintenance rate at a high current rate, namely applications such as automobiles and electric tools such as power tools.

### EMBODIMENTS OF THE INVENTION

<Lithium Composite Metal Oxide of Present Invention>

The lithium composite metal oxide of the present invention is a lithium composite metal oxide that contains Ni, Mn, Co and Fe, and has a BET specific surface area of 3 m²/g to 15 m²/g.

If the BET specific surface area is less than 3 m²/g or exceeds 15 m²/g, the discharge capacity maintenance rate of the resulting non-aqueous electrolyte secondary battery at a high current rate is inadequate. In relation thereto, the BET specific surface area of the lithium composite metal oxide is preferably 3 m²/g or more, and more preferably 5 m²/g or more.

In addition, in order to enhance filling properties, the BET specific surface area of the lithium composite metal oxide is preferably 15 m²/g or less, and more preferably 12 m²/g or less.

In order to enhance cycle properties and discharge capacity maintenance rate at a high current rate, the mean particle diameter in the lithium composite metal oxide of the present invention as measured by laser diffraction and scattering (to be referred to as “mean particle diameter”) is preferably 0.1 μm to less than 1 pm, more preferably 0.2 μm to 0.8 μm, and even more preferably 0.3 μm to 0.7 μm.

In order to obtain high capacity, the mean primary particle diameter in the lithium composite metal oxide of the present invention is preferably 0.05 μm to 0.4 μm, more preferably 0.07 μm to 0.35 μm, and even more preferably 0.1 μm to 0.3 μm.

In order to obtain a non-aqueous electrolyte secondary battery having even higher capacity and high discharge capacity maintenance rate at a high current rate, the lithium composite metal oxide of the present invention is preferably represented by the following formula (A):

Liₐ (Ni_{1-x-y-z}MnₓCo_{y}Fe_{z}) O₂ (A)

wherein, 0.9≦a≦1.3,

0.3≦x≦0.6,

0.01≦y≦0.4,

0.01≦z≦0.1, and

0.3≦x+y+z 0.7.

In the aforementioned formula (A), in order to obtain high capacity, a is preferably within the range of 0.9 to 1.3, and more preferably within the range of 0.95 to 1.15.

In the aforementioned formula (A), in order to enhance cycle properties in the case of using in a non-aqueous electrolyte secondary battery, the value of x is preferably within the range of 0.3 to 0.6, and more preferably within the range of 0.35 to 0.55.

In the aforementioned formula (A), in order to enhance discharge capacity maintenance rate at a high current rate in the case of using in a non-aqueous electrolyte secondary battery, the value of y is preferably within the range of 0.01 to 0.4, more preferably within the range of 0.03 to 0.3, and even more preferably within the range of 0.05 to 0.2.

In the aforementioned formula (A), in order to enhance cycle properties and thermal stability in the case of using in a non-aqueous electrolyte secondary battery, the value of z is preferably within the range of 0.01 to 0.1, more preferably within the range of 0.02 to 0.08, and even more preferably within the range of 0.03 to 0.07.

In the aforementioned formula (A), in order to enhance capacity and cycle properties in the case of using in a non-aqueous electrolyte secondary battery, the value of x +y +z is preferably within the range of 0.3 to 0.7, more preferably within the range of 0.4 to 0.6, and even more preferably within the range of 0.45 to 0.55.

A part of the Fe can be substituted with one or more types of elements selected from the group consisting of Al, Mg, Ba, Cu, Ca, Zn, V, Ti, Si, W, Mo, Nb and Zr, as far as that does not impair the effects of the present invention.

The lithium composite metal oxide of the present invention is composed of a mixture of primary particles, and secondary particles formed by aggregation of primary particles. The respective mean particle diameters of the primary particles and secondary particles can be measured by observing with a scanning electron microscope (SEM). In addition, the mean particle diameter of the lithium composite metal oxide of the present invention is measured by laser diffraction and scattering.

In order to further enhance the effects of the present invention, the structure of the lithium composite metal oxide of the present invention preferably has an α-NaFeO₂-type crystal structure, or in other words, a crystal structure assigned to the R-3m space group. The crystal structure of the lithium composite metal oxide can be identified from a powder X-ray diffraction pattern using CuKα for the radiation source.

In addition, a compound differing from the lithium composite metal oxide of the present invention may be adhered to the surface of particles composing the lithium composite metal oxide, as far as that does not impair the effects of the present invention. Examples of the aforementioned compound include compounds containing one or more types of elements selected from the group consisting of B, Al, Ga, In, Si, Ge, Sn, Mg and transition metal elements, preferably compounds containing one or more types of elements selected from the group consisting of B, Al, Mg, Ga, In and Sn, and even more preferably Al compounds.

Specific examples of such compounds include oxides, hydroxides, oxyhydroxides, carbonates, nitrates and organic acid salts of the aforementioned elements, and preferably include oxides, hydroxides and oxyhydroxides thereof. In addition, these compounds may also be used as a mixture. Among these compounds, alumina is used particularly preferably. In addition, these compounds may be heated after adhering.

This lithium composite metal oxide can be produced by the method of the present invention for producing a lithium composite metal oxide in particular.

<Method of Present Invention for Producing Lithium Composite Metal Oxide>

The method of the present invention for producing the lithium composite metal oxide comprises the following steps (1), (2) and (3) in that order:

(1) obtaining a co-precipitate slurry by bringing a raw material aqueous solution containing Ni ions, Mn ions, Co ions, Fe ions and sulfate ions into contact with alkali to form a co-precipitate;

(2) obtaining the co-precipitate from the co- precipitate slurry; and,

(3) obtaining a lithium composite metal oxide by mixing the co-precipitate and a lithium compound, and calcining the resulting mixture by holding at a temperature of 650° C. to 950° C.

<Method of Present Invention for Producing Lithium Composite Metal Oxide—Step (1)>

In the aforementioned step (1), the raw material aqueous solution containing Ni ions, Mn ions, Co ions, Fe ions and sulfate (SO₄²⁻) ions is preferably an aqueous solution obtained by dissolving sulfates, which respectively serve as raw materials containing Ni, Mn, Co and Fe, namely Ni sulfate, Mn sulfate, Co sulfate and Fe sulfate, in water. The Fe sulfate is preferably a sulfate of divalent Fe.

In addition, in the case where it is difficult to dissolve each of the raw materials containing Ni, Mn, Co and Fe in water, such as in the case where these raw materials are oxides, hydroxides or metal materials, these raw materials can be dissolved in an aqueous solution containing sulfuric acid to obtain a raw material aqueous solution containing Ni ions, Mn ions, Co ions, Fe ions and sulfate ions.

In step (1), examples of alkali include anhydrides of one or more types of compounds selected from the group consisting of KOH (potassium hydroxide), Li₂CO₃ (lithium carbonate), Na₂CO₃ (sodium carbonate), K₂CO₃ (potassium carbonate) and (NH₄)₂CO₃ (ammonium carbonate), and/or hydrates of one or more of the aforementioned compounds.

In step (1), an aqueous solution of the aforementioned alkaline compounds is used preferably. An example of an alkaline aqueous solution is aqueous ammonia. The concentration of alkali in the alkaline aqueous solution is normally about 0.5 M to 10 M, and preferably about 1 M to 8 M. In addition, from the viewpoint of production costs, an anhydride and/or hydrate of NaOH or KOH is preferably used for the alkali. In addition, two or more of these alkaline compounds may be used in combination.

Examples of contact methods in step (1) include adding an alkaline aqueous solution to the raw material aqueous solution to mix them, adding the raw material aqueous solution to an alkaline aqueous solution to mix them, and adding the raw material aqueous solution and an alkaline aqueous solution to water to mix them. The solutions are preferably stirred when mixed.

In addition, among the contact methods as described above, the method in which the raw material aqueous solution is added to an alkaline aqueous solution to mix them can be used preferably from the viewpoint of easily maintaining changes in pH. In this case, although the pH of the mixed liquid tends to decrease as the raw material aqueous solution is added to and mixed with the alkaline aqueous solution, the raw material aqueous solution is preferably added while adjusting the pH to be 9 or higher and preferably 10 or higher. In addition, among the raw material aqueous solution and alkaline aqueous solution, either or both of the aqueous solutions is preferably maintained at a temperature of 40° C. to 80° C. during the contact, since this allows the obtaining a co-precipitate having a more uniform composition.

During the aforementioned contact, although there are cases in which the co-precipitate may be obtained in the form of a powder, depending on the concentrations of the Ni ions, Mn ions, Co ions, Fe ions and sulfate ions in the aqueous solution, as well as the form of the alkali brought into contact with the aqueous solution (such as in the form of an aqueous solution or solid), it is preferably obtained in the form of a co-precipitate slurry.

In order to obtain a non-aqueous electrolyte secondary battery having higher capacity, the amount of

Mn (moles) to the total amount (moles) of Ni, Mn, Co and Fe in the raw material aqueous solution of step (1) is preferably 0.3 to 0.6.

In addition, in order to obtain a non-aqueous electrolyte secondary battery having enhanced cycle properties, the amount of Co (moles) to the total amount (moles) of Ni, Mn, Co and Fe in the raw material aqueous solution is preferably 0.01 to 0.4.

Moreover, in order to obtain a non-aqueous electrolyte secondary battery having greater safety, the amount of Fe (moles) to the total amount (moles) of Ni, Mn, Co and Fe in the raw material aqueous solution is preferably 0.01 to 0.1.

In addition, in order to obtain a non-aqueous electrolyte secondary battery having even higher capacity, the amount of Ni (moles) to the total amount (moles) of Ni, Mn, Co and Fe in the raw material aqueous solution is preferably 0.3 to 0.7.

<Method of Present Invention for Producing Lithium Composite Metal Oxide—Step (2)>

In step (2), the co-precipitate is obtained from the aforementioned co-precipitate slurry.

Step (2) may be carried out by any method, provided a co-precipitate can be obtained. However, from the viewpoint of ease of the procedure, a method employing solid-liquid separation by filtration and the like is used preferably. The co-precipitate can also be obtained by a method such as spray drying that uses the co- precipitate slurry and evaporates the liquid by heating.

The aforementioned step (2) is preferably the step (2′) indicated below, in the case where a co-precipitate is obtained by solid-liquid separation.

Step (2′): obtaining the co-precipitate by subjecting the aforementioned co-precipitate slurry to solid-liquid separation followed by washing and drying.

In step (2′), alkali and sulfuric acid present in the solid fraction obtained following solid-liquid separation can be removed by washing even in the case of being present in excess.

Water is preferably used as the washing liquid in order to efficiently wash the solid fraction. Furthermore, a water-soluble organic solvent such as alcohol or acetone may also be added to the washing liquid as necessary. In addition, washing may be carried out two or more times, and for example, the solid fraction can be rewashed with a water-soluble organic solvent as described above after having washed with water.

In step (2′), the co-precipitate is obtained by drying after washing.

Although drying is normally carried out by heat treatment, it may also be carried out by fan drying or vacuum drying and the like. In the case of carrying out drying by heat treatment, drying is normally carried out at 50° C. to 300° C. and preferably at about 100° C. to 200° C.

The BET specific surface area of the co-precipitate obtained according to step (2′) is normally about 10 m²/g to 130 m²/g. The BET specific surface area of the co-precipitate can be adjusted according to the drying temperature.

The BET specific surface area of the co-precipitate is preferably 20 m²/g or more, and more preferably 30 m²/g or more in order to promote reactivity during calcination described below. In addition, from the viewpoint of ease of the procedure, the BET specific surface area of the co-precipitate is preferably 100 m²/g or less, and more preferably 90 m²/g or less.

In addition, the co-precipitate is normally composed of a mixture of primary particles having a particle diameter of 0.001 μm to 0.1 and secondary particles having a particle diameter of 1 μm to 100 μm, which are formed by aggregation of the primary particles. Particle diameter of the primary particles and secondary particles refer to the equivalent spherical diameter which can be measured by observing with a scanning electron microscope (also referred to as “SEM”). The particle diameter of the secondary particles is preferably 1 μm to 50 μm, and more preferably 1 μm to 30 μm.

<Method of Present Invention for Producing Lithium Composite Metal Oxide—Step (3)>

In step (3), a mixture, which is obtained by mixing the co-precipitate obtained as previously described with a lithium compound, is calcined to obtain a lithium composite metal oxide.

Examples of the lithium compound include anhydrides of one or more types of compounds selected from the group consisting of lithium hydroxide, lithium chloride, lithium nitrate and lithium carbonate, and/or hydrates of one or more types of the aforementioned compounds.

Although mixing may be carried out by dry mixing or wet mixing, from the viewpoint of convenience, dry mixing is preferable. Examples of mixing devices include stirring mixers, V-type mixers, W-type mixers, ribbon mixers, drum mixers and ball mills.

The holding temperature during the aforementioned calcination is an important factor for adjusting the BET specific surface area of the lithium composite metal oxide. Normally, the BET specific surface area tends to decrease as the holding temperature becomes higher.

For example, the BET specific surface area of the lithium composite metal oxide obtained by the calcination of holding at 1000° C. in step (3) is as low as 0.3 m²/g, and the discharge capacity maintenance rate at a high current rate is not adequate. The BET specific surface area tends to increase as the holding temperature becomes lower. The holding temperature is preferably within the range of 650° C. to 950° C.

The duration, for which the aforementioned holding temperature is held, is normally 0.1 hours to 20 hours, and preferably 0.5 hours to 8 hours. The heating rate to the aforementioned holding temperature is normally 50° C. to 400° C./hour, and the cooling rate from the aforementioned holding temperature to room temperature is normally 10° C. to 400° C./hour.

In addition, while air, oxygen, nitrogen, argon or a mixed gas thereof can be used for the atmosphere during the calcination, an air atmosphere is preferable.

During the aforementioned calcination, the mixture may also contain a reaction accelerator such as ammonium fluoride or boric acid.

Specific examples of reaction accelerators include sulfates such as K₂SO₄ or Na₂SO₄; carbonates such as K₂CO₃ or Na₂CO₃; chlorides such as KCl or NH₄Cl; fluorides such as LiF, NaF, KF or NH₄F; and boric acid. Sulfates are preferable, and K₂SO₄ is more preferable.

As a result of the mixture containing a reaction accelerator, reactivity during calcining the mixture may be improved, and the BET specific surface area of the resulting lithium composite metal oxide may be adjusted. Normally, in the cases where the holding temperature during the calcination are the same, the BET specific surface area tends to become smaller, as the content of reaction accelerator in the mixture increases. In addition, two or more types of reaction accelerators can also be used in combination. The reaction accelerator may be added and mixed, when mixing the co-precipitate and lithium compound. In addition, the reaction accelerator may remain in the lithium composite metal oxide, or be removed by washing, evaporation and the like.

In addition, following the aforementioned firing, the resulting lithium composite metal oxide may be crushed using a ball mill, jet mill, or the like. In some cases, the BET specific surface area of the lithium composite metal oxide may be adjusted by crushing. In addition, crushing and calcining may be repeated two or more times each. In addition, the lithium composite metal oxide can also be washed or sized as necessary.

Descriptions relating to the lithium composite metal oxide of the present invention can also be referred to for the lithium composite metal oxide obtained by the production method of the present invention.

<Positive Electrode Active Material for Non-Aqueous Electrolyte Secondary Battery of Present Invention>

The positive electrode active material for a non-aqueous electrolyte secondary battery of the present invention is mainly composed of the lithium composite metal oxide of the present invention, and is preferable for a non-aqueous electrolyte secondary battery.

<Positive Electrode for Non-Aqueous Electrolyte

Secondary Battery of Present Invention>

The positive electrode for a non-aqueous electrolyte secondary battery of the present invention has the positive electrode active material for a non-aqueous electrolyte secondary battery of the present invention, and can be produced, for example, in the manner described below.

A positive electrode for a non-aqueous electrolyte secondary battery of the present invention can be produced by loading a positive electrode mixture containing the positive electrode active material of the present invention, an electrically conductive material and a binder on a positive electrode current collector.

A carbonaceous material can be used as the aforementioned conductive material, and examples of carbonaceous materials include graphite powder, carbon black (such as acetylene black) and fibrous carbonaceous materials. Carbon black enhances internal electrical conductivity of the positive electrode, and improves charge-discharge efficiency and output characteristics, if added only a small amount to a positive electrode mixture, due its fineness and large surface area. However, if carbon black is added excessively, binding, by binder, between the positive electrode mixture and positive electrode current collector decreases, thereby causing an increase in internal resistance.

Normally, the ratio of the conductive material in the positive electrode mixture is 5 parts by weight to 20 parts by weight, relative to 100 parts by weight of the positive electrode active material. This ratio can be lowered in the case of using a fibrous carbonaceous material such as graphite carbon fibers or carbon nanotubes.

A thermoplastic resin can be used as the aforementioned binder, and specific examples thereof include fluorine resins such as polyvinylidene fluoride (to also be referred to as “PVdF”), polytetrafluoroethylene (also referred to as “PTFE”), ethylene tetrafluoride-propylene hexafluoride- vinylidene fluoride copolymer, propylene hexafluoride- vinylidene fluoride copolymer, or ethylene tetrafluoride-perfluorovinyl ether copolymer; and polyolefins such as polyethylene or polypropylene. In addition, two or more types thereof may be used as a mixture.

In addition, a positive electrode mixture providing superior binding with the positive electrode current collector can be obtained by using a fluorine resin and polyolefin resin as binders, in the ratio of the fluorine resin to the positive electrode mixture of 1% by weight to 10% by weight, and in the ratio of the polyolefin resin to the positive electrode mixture of 1% by weight to 2% by weight.

While a conductor such as Al, Ni or stainless steel can be used as the aforementioned positive electrode current collector, Al is preferable from the viewpoints of being easily formed into a thin film and being inexpensive.

Examples of methods used to load the positive electrode mixture on the positive electrode current collector include methods using compression molding; and methods consisting of forming a paste using an organic solvent, applying the paste onto the positive electrode current collector, and pressing after drying the paste to adhere it to the positive electrode current collector. In the case of forming a paste, a slurry is prepared consisting of the positive electrode active material, conducting material, binder, and organic solvent.

Examples of organic solvents include amine-based solvents such as N,N-dimethylaminopropylamine or diethylene triamine; ether-based solvents such as tetrahydrofuran; ketone-based solvents such as methyl ethyl ketone; ester-based solvents such as methyl acetate; and amide-based solvents such as dimethylacetoamide or N-methyl-2-pyrrolidone (to also be referred to as “NMP”).

Examples of methods used to apply the positive electrode mixture onto the positive electrode current collector include slit die coating, screen coating, curtain coating, knife coating, gravure coating, and electrostatic spraying.

<Non-Aqueous Electrolyte Secondary Battery of Present Invention>

The non-aqueous electrolyte secondary battery of the present invention has the positive electrode for a non-aqueous electrolyte secondary battery of the present invention.

The non-aqueous electrolyte secondary battery of the present, and particularly a lithium secondary battery, can be produced by, for example, impregnating, with an electrolytic solution, a structure obtained by laminating a separator, negative electrode and the aforementioned positive electrode. More specifically, the non-aqueous electrolyte secondary battery of the present invention can be produced by, for example, housing, in a battery casing, an electrode assembly obtained by laminating and winding a separator, negative electrode and the aforementioned positive electrode, and then impregnating the assembly with an electrolytic solution. In addition, the non-aqueous electrolyte secondary battery of the present invention, and particularly a lithium secondary battery, can be produced by, for example, optionally impregnating, with an electrolytic solution, a structure obtained by laminating a solid electrolyte, optional separator, negative electrode and the aforementioned positive electrode.

Examples of the shape of the aforementioned electrode assembly include shapes such that a cross-section is in the shape of a circle, oval, rectangle or rectangular shape having corners, the cross-section being obtained when cutting the aforementioned electrode assembly in a direction perpendicular to the axis about which the electrode assembly is wound. In addition, examples of shapes of the battery include a film shape, coin shape, cylindrical shape, and prismatic shape.

<Negative Electrode>

The aforementioned negative electrode is that having a lower potential than the positive electrode, and can be doped and de-doped with lithium ions. Examples thereof include an electrode obtained by loading a negative electrode mixture containing a negative electrode material onto a negative electrode current collector, and an electrode composed of a negative electrode material alone.

Examples of negative electrode materials include carbonaceous materials, chalcogen compounds (such as oxides or sulfides), nitrides, metals or alloys, which can be doped and de-doped with lithium ions at a lower potential than the positive electrode. In addition, these negative electrode materials may also be used as a mixture.

The following lists examples of the aforementioned negative electrode materials. Specific examples of the aforementioned carbonaceous materials include graphite such as natural graphite or artificial graphite, coke, carbon black, pyrolyzed carbon, carbon fibers and fired organic polymer compounds.

Specific examples of the aforementioned oxides include oxides of silicon represented by the formula SiOₓ (x represents a positive real number) such as SiO₂ or SiO; oxides of titanium represented by the formula TiOₓ (x represents a positive real number) such as TiO₂ or TiO; oxides of vanadium represented by the formula VOₓ (x represents a positive real number) such as V₂O₅ or VO₂; oxides of iron represented by the formula FeOₓ (x represents a positive real number) such as Fe₃O₄, Fe₂O₃ or FeO; oxides of tin represented by the formula SnO (x represents a positive real number) such as SnO₂ or SnO; oxides of tungsten represented by the formula WOₓ (x represents a positive real number) such as WO₃ or WO₂; and composite metal oxides containing lithium and titanium and/or vanadium such as Li₄Ti₅O₁₂ or LiVO₂.

Specific examples of the aforementioned sulfides include sulfides of titanium represented by the formula TiS (x represents a positive real number) such as Ti₂S₃, TiS₂ or TiS; sulfides of vanadium represented by the formula VSₓ (x represents a positive real number) such as V₃S₄, VS₂ or VS; sulfides of iron represented by the formula FeS (x represents a positive real number) such as Fe₃S₄, FeS₂ or FeS; sulfides of molybdenum represented by the formula MoSₓ (x represents a positive real number) such as Mo₂S₃ or MoS₂; sulfides of tin represented by the formula SnS (x represents a positive real number) such as SnS₂ or SnS; sulfides of tungsten represented by the formula WSₓ (x represents a positive real number) such as WS₂; sulfides of antimony represented by the formula SbSₓ (x represents a positive real number) such as Sb₂S₃; and sulfides of selenium represented by the formula SeS (x represents a positive real number) such as Se₅S₃, SeS₂ or SeS.

Examples of the aforementioned nitrides include lithium-containing nitrides such as Li₃N or Li₃₋ₓAₓN (A represents Ni and/or Co and 0<x<3).

These carbonaceous materials, oxides, sulfides and nitrides may also be used in combination, and may be crystalline or amorphous. In addition, these carbonaceous materials, oxides, sulfides and nitrides may be mainly used as an electrode by loading onto a negative electrode current collector.

In addition, specific examples of the aforementioned metals include lithium metal, silicon metal and tin metal. In addition, examples of the aforementioned alloys include lithium alloys such as Li—Al, Li—Ni or Li—Si; silicon alloys such as Si—Zn; tin alloys such as Sn—Mn, Sn—Co, Sn—Ni, Sn—Cu or Sn—La; and alloys such as Cu₂Sb or La₃Ni₂Sn₇. These metals and alloys are mainly used alone as electrodes (such as being used in the form of a foil).

Among the aforementioned negative electrode materials, carbonaceous materials mainly composed of natural graphite or artificial graphite are used preferably from the viewpoints of high electrical potential flatness, low average discharge potential, and favorable cycle properties. The shape of the carbonaceous material may be in the form of flakes as in the case of natural graphite, spherical as in the case of mesocarbon microbeads, fibrous as in the case of graphite carbon fibers, or an aggregate of a fine powder.

The aforementioned negative electrode mixture may also contain a binder as necessary. Examples of binders include thermoplastic resins, and specific examples thereof include PVdF, thermoplastic polyimide, carboxymethyl cellulose, polyethylene, and polypropylene.

Examples of the aforementioned negative electrode current collector include conductors such as Cu, Ni or stainless steel, and Cu is used preferably, from the viewpoints of less likelihood of forming an alloy with lithium and being easily formed into a thin film. Methods used to load the negative electrode mixture on the aforementioned negative electrode current collector are the same as those listed for a positive electrode. Examples thereof include methods using compression molding; and methods consisting of forming a paste using an organic solvent, applying the paste onto the negative electrode current collector, and pressing after drying the paste to adhere it to the negative electrode current collector.

<Separator>

Materials having the form of a porous film, non-woven fabric or woven fabric and the like and being composed of a polyolefin resin such as polyethylene or polypropylene, a fluorine resin or a nitrogen-containing aromatic polymer and the like, can be used as the aforementioned separator. Two or more types of the aforementioned materials may also be as a separator, and the aforementioned materials may be laminated. Examples of separators are described in, for example, JP-A-2000-30686, and JP-A-H10-324758.

The thickness of the separator is preferably as thin as possible, provided mechanical strength is retained, from the viewpoints of increased volumetric energy density of the battery and low internal resistance, and is normally about 5 μm to 200 μm, and preferably about 5 μm to 40 μm.

In the present invention, the air permeability of the separator as determined according to the Gurley method is preferably 50 seconds/100 cc to 300 seconds/100 cc, and more preferably 50 seconds/100 cc to 200 seconds/100 cc, from the viewpoint of ion permeability. In addition, the porosity of the separator is normally 30% by volume to 80% by volume, and preferably 40% by volume to 70% by volume. The separator may also be in the form of a laminate consisting of separators having different porosities.

The separator preferably has a porous film containing a thermoplastic resin. In a non-aqueous electrolyte secondary battery, the separator preferably has a function that inhibits (shuts down) the flow of excess current by interrupting the current, when abnormal current has flown within the battery, due to a short-circuit and the like, between the positive electrode and negative electrode. The shutdown is carried out by blocking micropores of the porous film in the separator in the case where the normal working temperature has been exceeded. After shutting down the current, the shutdown state is preferably maintained without causing the film to be ruptured by the elevated temperature even if the temperature within the battery rises to a high temperature to a certain extent.

<Separator-Laminated Film>

An example of the separator is a laminated film obtained by laminating a heat-resistant porous layer and a porous film. As a result of using the aforementioned film as a separator, heat resistance of the secondary battery of the present invention can be further enhanced. The heat-resistant porous layer may be laminated on both sides of the porous film.

The following provides an explanation of a laminated film obtained by laminating a heat-resistant porous layer and porous film as described above.

<Separator-Laminated Film/Heat-Resistant Porous Layer>

In the aforementioned laminated film, the heat-resistant porous layer is a film that has higher heat resistance than the porous film, and the aforementioned heat-resistant porous layer may be formed of an inorganic powder or may contain a heat-resistant resin. When the heat-resistant porous layer containing a heat-resistant resin, a heat-resistant porous layer can be formed by a simple method such as coating.

Examples of heat-resistant resins include polyamide, polyimide, polyamide-imide, polycarbonate, polyacetal, polysulfone, polyphenylene sulfide, polyether ketone, aromatic polyester, polyether sulfone and polyether imide. In order to further enhance heat resistance, polyamide, polyimide, polyamide-imide, polyether sulfone and polyether imide are preferable, and polyamide, polyimide or polyamide-imide is more preferable. Even more preferable examples include nitrogen-containing aromatic polymers such as aromatic polyamides (para-oriented aromatic polyamides or meta-oriented polyamides), aromatic polyimides or aromatic polyamide-imides; and particularly preferable examples include para-oriented aromatic polyamides (also referred to as “para-aramids”). In addition, examples of heat-resistant resins include poly-4-methylpentene-1 and cyclic olefin-based polymers.

The use of these heat-resistant resins makes it possible to further enhance the heat resistance of the laminated film, or in other words, further higher the heat-induced film rupture temperature of the laminated film. In the case of using a nitrogen-containing aromatic polymer among these heat-resistant resins, compatibility with electrolytic solution, namely liquid retention in the heat-resistant porous layer, may be improved, perhaps due to intramolecular polarity; and the impregnation rate of electrolytic solution during the production of a non-aqueous electrolyte secondary battery, and the charge-discharge capacity of the non-aqueous electrolyte secondary battery also be further increased.

The heat-induced film rupture temperature of the laminated film depends on the type of heat-resistant resin, which is selected and used according to the type and objective of use. More specifically, the heat-induced film rupture temperature can be controlled to about 400° C. when the aforementioned nitrogen-containing aromatic polymer is used as the heat-resistant resin, to about 250° C. when poly-4-pentene-1, or to about 300° C. when a cyclic polyolefin-based polymer. In addition, when the heat-resistant porous layer is composed of an inorganic powder, the heat-induced film rupture temperature can be controlled to, for example, 500° C. or higher.

The aforementioned para-aramids are obtained by condensation polymerization of a para-oriented aromatic diamine and para-oriented aromatic dicarboxylic acid halide, and are substantially composed of repeating units in which amide bonds are bonded in the para orientation of an aromatic ring or in orientation equivalent thereto (orientation in which bonds extend coaxially or in parallel in opposite directions in the manner of, for example, 4,4′-biphenylene, 1,5-naphthalene or 2,6-naphthalene). Specific examples include para-aramids having a structure in the para orientation or structure equivalent to the para orientation, such as poly(paraphenylene terephthalamide), poly(parabenzamide), poly(4,4′-benzanilide terephthalamide), poly(paraphenylene-4,4′-benzanilide terephthalamide), poly(paraphenylene-4,4′-biphenylene carboxylic acid amide), poly(paraphenylene-2,6-naphthlene carboxylic acid amide), poly(2-chloro-paraphenylene terephthalamide), or paraphenylene terephthalamide/2,6-dichloroparaphenylene terephthalamide copolymer.

A completely aromatic polyimide produced by condensation polymerization of an aromatic diacid anhydride and diamine is preferable as the aforementioned aromatic polyimide. Specific examples of the aforementioned diacid anhydride include pyromellitic acid dianhydride, 3,3′4,4′-diphenylosulfone tetracarboxylic acid dianhydride, 3,3′,4,4′-benzophenone tetracarboxylic acid dianhydride, 2,2′-bis(3,4-dicarboxyphenyl)hexafluoropropane, and 3,3,4,4′-biphenyltetracarboxylic acid dianhydride. Examples of the aforementioned diamines include oxydianiline, paraphenylene diamine, benzophenone diamine, 3,3′-methylene diamine, 3,3′-diaminobenzophenone, 3,3′-diaminodiphenylsulfone, and 1,5′-naphthalene diamine. In addition, polyimides that are soluble in solvent can be used preferably. Examples of such polyimides include polyimides of polycondensates of 3,3′,4,4′-diphenylsulfone tetracarboxylic acid dianhydrides, and aromatic diamines.

Examples of the aforementioned aromatic polyamide-imides include those obtained by condensation polymerization using aromatic dicarboxylic acids and aromatic diisocyanates, and those obtained by condensation polymerization using aromatic diacid anhydrides and aromatic diisocyanates. Specific examples of aromatic dicarboxylic acids include isophthalic acid and terephthalic acid. In addition, specific examples of aromatic diacid anhydrides include trimellitic anhydride. Specific examples of aromatic diisocyanates include 4,4′-diphenylmethane diisocyanate, 2,4-tolylene diisocyanate, 2,6-tolylene diisocyanate, orthotolylene diisocyanate, and m-xylene diisocyanate.

In addition, in order to further enhance ion permeability, the thickness of the heat-resistant porous layer is preferably 1 μm to 10 μm, more preferably 1 μm to 5 μm, and particularly preferably 1 μm to 4 μm, and is in the form of a thin heat-resistant porous layer. In addition, the heat-resistant porous layer has micropores, and the pore size (diameter) thereof is normally 3 μm or less, and preferably 1 μm or less. In addition, in the case where the heat-resistant porous layer contains a thermoplastic resin, the heat-resistant porous layer can also contain a filler described below.

<Separator-Laminated Film—Heat-Resistant Resin Layer (Containing Thermoplastic Resin)>

In addition, in the case where the heat-resistant porous layer contains a heat-resistant resin, the heat-resistant porous layer may also contain one or more types of filler. The material of the filler may be selected from any of an organic powder, inorganic powder, or mixture thereof. The mean particle diameter of the particles composing the filler is preferably 0.01 μm to 1 μm.

Examples of the aforementioned filler include powders composed of organic substances, such as homopolymers of or copolymers of two or more types of styrene, vinyl ketone, acrylonitrile, methyl methacrylic acid, ethyl methacrylic acid, glycidyl methacrylate, glycidyl acrylate or methyl acrylic acid; fluorine-based resins such as polytetrafluoroethylene, ethylene tetrafluoride-propylene hexafluoride copolymer, ethylene tetrafluoride-ethylene copolymer, or polyvinylidene fluoride; melamine resins; urea resins; polyolefin resins; and polymethacrylates. The aforementioned organic powders may be used alone or two or more types can be used as a mixture. Among these organic powders, polytetrafluoroethylene powder is preferable from the viewpoint of chemical stability.

Examples of the aforementioned inorganic powder include powders composed of inorganic substances, such as metal oxides, metal nitrides, metal carbides, metal hydroxides, carbonates or sulfates. Among these, powders composed of an inorganic substance having low electrical conductivity are used preferably.

Specific examples thereof include powders composed of alumina, silica, titanium dioxide, or calcium carbonate. The aforementioned inorganic powders may be used alone or two or more types can be used as a mixture. Among these inorganic powders, alumina powder is preferable from the viewpoint of chemical stability. More preferably, all of the particles composing the filler are alumina particles; and even more preferably, all of the particles composing the filler are alumina particles, and all or a portion thereof are roughly spherical alumina particles. Incidentally, when the heat-resistant porous layer is formed of an inorganic powder, the aforementioned examples of inorganic powders may be used, and they may be mixed with a binder as necessary.

While depending on the specific gravity of the filler material, in the case where the heat-resistant porous layer contains a heat-resistant resin, and, for example, all of the particles composing the filler are alumina particles, the content of the filler is normally 5 parts by weight to 95 parts by weight, preferably 20 parts by weight to 95 parts by weight, and more preferably 30 parts by weight to 90 parts by weight, based on 100 parts by weight of the total weight of the heat-resistant porous layer. These ranges can be suitably set according to the specific gravity of the filler material.

Examples of filler shapes include approximate spheres, plates, columns, needles, whiskers and fibers. Although any of these particles can be used, roughly spherical particles are preferable from the viewpoint of facilitating the formation of uniform pores. Examples of roughly spherical particles include particles having a particle aspect ratio (particle long axis/particle short axis) of 1 to 1.5. Particle aspect ratio can be measured using an electron micrograph.

<Separator-Laminated Film—Porous Film>

In the aforementioned laminated film, the porous film preferably has micropores and a shutdown function. In this case, the porous film contains a thermoplastic resin. The size of the micropores in the porous film is normally 3 μm or less, and preferably 1 μm or less. The porosity of the porous film is normally 30% by volume to 80% by volume, and preferably 40% by volume to 70% by volume. In a non-aqueous electrolyte secondary battery, a porous film containing a thermoplastic resin can block the micropores due to softening of the thermoplastic resin composing the porous film, when the normal working temperature has been exceeded.

A thermoplastic resin that does not dissolve in electrolytic solution in a non-aqueous electrolyte secondary battery may be selected as the aforementioned thermoplastic resin. Specific examples thereof include polyolefin resins such as polyethylene or polypropylene and thermoplastic polyurethane resin. Two or more types thereof may be used as a mixture.

Polyethylene is preferably contained in order to induce shutdown by softening at a lower temperature. Specific examples of polyethylene include low-density polyethylene, high-density polyethylene, and linear polyethylene, as well as ultra-high molecular weight polyethylene having a molecular weight of 1 million or more.

In order to further enhance puncture strength of the porous film, the thermoplastic resin composing the aforementioned film preferably at least contains ultra-high molecular weight polyethylene. In addition, in terms of production of the porous film, in some cases, the thermoplastic resin may preferably contain a wax composed of a polyolefin having a low molecular weight (weight average molecular weight of 10,000 or less).

In addition, the thickness of the porous film in the laminated film is normally 3 μm to 30 μm, and more preferably 3 μm to 25 μm. In addition, in the present invention, the thickness of the laminated film is normally 40 μm or less, and preferably 20 μm or less. In addition, when the thickness of the heat-resistant porous layer is defined as A (μm), and the thickness of the porous film is defined as B (μm), then the value of A/B is preferably 0.1 to 1.

<Electrolytic Solution>

In a secondary battery, the electrolytic solution normally contains an electrolyte and an organic solvent.

Examples of electrolytes include lithium salts such as LiClO₄, LiPF₆, LiAsF₆, LiSbF₆, LiBF₄, LiCF₃SO₃, LiN (SO₂CF₃)₂, LiN (SO₂C₂F₅) _{2,} LiN (SO₂CF₃) (COCF₃) , Li (C₄F₉SO₃), LiC(SO₂CF₃)₃, Li₂B₁₀Cl₁₀, LiBOB (wherein BOB represents bis(oxalato)borate), lithium salts of lower aliphatic carboxylic acids or LiAlCl₄, and two or more types thereof may be used as a mixture. At least one type selected from the group consisting of fluorine-containing LiPF₆, LiAsF₆, LiSbF₆, LiBF₄, LiCF₃SO₃, LiN(SO₂CF₃)₂ and LiC(SO₂CF₃)₃ is normally used as the lithium salt.

Examples of organic solvents include carbonates such as propylene carbonate, ethylene carbonate, dimethyl carbonate, diethyl carbonate, ethylmethyl carbonate, 4-trifluoromethyl- 1,3-dioxolan-2-one or 1,2-di(methoxycarbonyloxy)ethane; ethers such as 1,2-dimethoxyethane, 1,3-dimethoxypropane, pentafluoropropyl methyl ether, 2,2,3,3-tetrafluoropropyl difluoromethyl ether, tetrahydrofuran or 2-methyltetrahydrofuran; esters such as methyl formate, methyl acetate or γ-butyrolactone; nitriles such as acetonitrile or butyronitrile; amides such as N,N-dimethylformamide or N,N-dimethylacetoamide; carbamates such as 3-methyl-2- oxazolidone; sulfur-containing compounds such as sulfolan, dimethylsulfoxide or 1,3-propane sultone; and organic solvents obtained by introducing a fluorine substituent into the aforementioned organic solvents, and normally two or more types thereof are used as a mixture.

Among these, a mixed solvent containing a carbonate is preferable; and a mixed solvent of a cyclic carbonate and acyclic carbonate, or a mixed solvent of a cyclic carbonate and ether is more preferable. As a mixed solvent of a cyclic carbonate and acyclic carbonate, a mixed solvent of ethylene carbonate, dimethyl carbonate and ethylmethyl carbonate is preferable from the viewpoints of having a wide working temperature range, superior load characteristics, and refractoriness even in the case of using a graphite material such as natural graphite or artificial graphite as the active material of the negative electrode. In addition, an electrolytic solution containing a fluorine-containing lithium salt such as LiPF₆ and an organic solvent having a fluorine substituent is preferable from the viewpoint of allowing the obtaining of superior safety-improving effects in particular. A mixed solvent containing an ether having a fluorine substituent, such as pentafluoropropyl methyl ether or 2,2,3,3-tetrafluoropropyl difluoromethyl ether, and a dimethyl carbonate is more preferable, due to superior large current discharge characteristics.

<Solid Electrolyte>

A solid electrolyte may be used instead of the aforementioned electrolytic solution. Examples of solid electrolytes that can be used include organic polymer electrolytes, such as polyethylene oxide-based polymer compounds or polymer compounds containing at least one type of polyorganosiloxane chain or polyoxyalkylene chain. In addition, a so-called gel type of solid electrolyte, that is obtained by retaining a non-aqueous electrolytic solution in a polymer compound, can also be used.

In addition, an inorganic solid electrolyte, that contains a sulfide, such as Li₂S-SiS₂, Li₂S-GeS₂, Li₂S-P₂S₅, Li₂S-B₂S₃, Li₂S-SiS₂-Li₃PO₄ or Li₂S-SiS₂-Li₂SO₄, may also be used.

Safety can be further enhanced by using these solid electrolytes. In addition, in the case of using a solid electrolyte in the non-aqueous electrolyte secondary battery of the present invention, the solid electrolyte may also fulfill the role of a separator, and in such cases, a separator may not be required.

### EXAMPLES

The following provides a more detailed explanation of examples of the present invention by using examples thereof. Furthermore, evaluations and charge-discharge testing of the lithium composite metal oxide (positive electrode active material) were carried out in the manner described below.

(1) Production of Positive Electrode

PVdF (using N-methyl-2-pyrrolidone as organic solvent) as a binder was added to and kneaded with a mixture of a positive electrode active material and a conducting material (acetylene black and graphite mixed at a ratio of 9:1 (weight ratio)) to obtain a paste having a composition ratio of active material to conducting material to binder (PVdF) of 86:10:4 (weight ratio), followed by applying the aforementioned paste onto Al foil having a thickness of 40 μm as a current collector, and vacuum-drying it for 8 hours at 150° C. to obtain a positive electrode.

(2) Production of Non-Aqueous Electrolyte Secondary Battery (Coin Cell)

The positive electrode was placed on the lower cover of a coin cell (Housen Co., Ltd.) with the aluminum foil side facing downward, a laminated film separator (obtained by laminating a heat-resistant porous layer on a polyethylene porous film, thickness: 16 μm) described below was then placed thereon, followed by injection of 300 μl of electrolytic solution therein. This electrolytic solution was obtained by dissolving LiPF₆ to a concentration of 1 mole/liter in a mixture of ethylene carbonate (EC), dimethyl carbonate (DMC) and ethylmethyl carbonate (EMC) mixed at a ratio of 30:35:35 (volume ratio) (also expressed as “LiPF₆/EC+DMC+EMC”).

Next, a negative electrode in the form of metal lithium was placed on the upper side of the laminated film separator, and an upper cover was placed thereon with a gasket interposed therebetween, followed by clamping with a crimping machine to produce a non-aqueous electrolyte secondary battery (coin-type battery R2032).

The battery was assembled in a safety cabinet containing an argon atmosphere.

(3) Charge-Discharge Test

A discharge rate test was carried out under the conditions indicated below using the coin-type battery obtained according to (2) above. The 0.2 C discharge capacity, 1 C discharge capacity, 5 C discharge capacity, and 10 C discharge capacity were respectively determined in the discharge rate test in the manner described below.

Testing temperature: 25° C.

Maximum charging voltage: 4.3 V

Charging time: 8 hours

Charging current: 0.3 mA/cm²

When discharging, the battery was discharged such that the minimum discharge voltage is maintained at 2.5 V and the discharge current is changed in the manner indicated below. A high value for the discharge capacity at 10 C (high current rate) means that a high discharge maintenance rate is demonstrated at a high current rate.

1st discharge cycle (0.2 C): discharge current of 0.3 mA/cm²

2nd discharge cycle (1 C): discharge current of 1.5 mA/cm²

3rd discharge cycle (5 C): discharge current of 7.5 mA / cm²

4th discharge cycle (10 C): discharge current of 15 mA/cm²

(4) Evaluation of Lithium Composite Metal Oxide

Evaluation 1: Compositional Analysis of Lithium Composite Metal Oxide

After dissolving the lithium composite metal oxide in hydrochloric acid, the composition of the lithium composite metal oxide was analyzed using inductively-coupled plasma atomic emission spectroscopy (SII, Model SPS3000).

Evaluation 2: Measurement of BET Specific Surface Area of Lithium Composite Metal Oxide

1 g of lithium composite metal oxide to be analyzed was dried for 15 minutes at 150° C. in a nitrogen atmosphere, followed by measuring BET specific surface area using the FlowSorb II 2300 manufactured by Micromeritics Instrument Corp.

Evaluation 3: Measurement of Mean Particle Diameter (Equivalent Spherical Diameter) of Lithium Composite Metal Oxide

0.1 g of lithium composite metal oxide to be analyzed was placed in 50 ml of 0.2% by weight aqueous sodium hexametaphosphate solution, and a dispersion obtained by dispersing the aforementioned powder was used as a sample. The particle size distribution of this sample was then measured using the Mastersizer 2000 manufactured by Malvern Instruments Ltd. (laser diffraction and scattering particle size distribution measuring system) to obtain a volume-based cumulative particle size distribution curve. The value of particle diameter at 50% accumulation as viewed from the side of smaller particles was used as the mean particle diameter of the powder.

Evaluation 4: Measurement of Mean Primary Particle Diameter of Lithium Composite Metal Oxide

Particles composing the lithium composite metal oxide were placed on an electrically conductive sheet affixed to a sample stage, and the particles were observed with a scanning electron microscope (SEM) by irradiating with an electron beam having an acceleration voltage of 20 kV, using the JSM-5510 scanning electron microscope manufactured by JEOL Ltd. Mean primary particle diameter was determined by randomly extracting 50 primary particles from the image obtained by SEM observation (SEM micrograph), measuring their respective particle diameters, and calculating the mean value thereof.

### Comparative Example 1

<1. Production of Lithium Composite Metal Oxide>

Nickel sulfate hexahydrate as a nickel water-soluble salt, manganese sulfate monohydrate as a manganese water-soluble salt, cobalt sulfate heptahydrate as a cobalt water-soluble salt, and iron (II) sulfate heptahydrate as an iron water-soluble salt were respectively weighed out to a ratio of Ni:Mn:Co:Fe of 0.49:0.3:0.2:0.01, followed by dissolving in pure water to obtain a transition metal aqueous solution containing Ni, Mn, Co and Fe. An aqueous potassium hydroxide solution as an alkaline metal aqueous solution was added to this transition metal aqueous solution, and co-precipitated to form a co-precipitate and obtain a co-precipitate slurry. The resulting slurry was then subjected to solid-liquid separation and washed with distilled water to obtain a transition metal composite hydroxide. The obtained hydroxide was then dried at 150° C. to obtain a co-precipitate Q¹.

<2. Production and Evaluation of Lithium Composite Metal Oxide>

The co-precipitate Q¹, lithium carbonate and potassium sulfate as an inert fusing agent were mixed in a mortar to obtain a mixture. Next, the aforementioned mixture was placed in an alumina calcination container, calcined by holding it for 6 hours in an air atmosphere at 1000° C. using an electric furnace, and cooled to room temperature to obtain a calcination product, followed by crushing, washing with decantation with distilled water, filtering and drying for 6 hours at 300° C. to obtain a powdered lithium composite metal oxide R¹.

When the composition of the aforementioned R¹ was analyzed, the molar ratio of Li:Ni:Mn:Co:Fe was 1.13:0.49:0.3:0.2:0.01, and the BET specific surface area was 0.2 m²/g. In addition, the mean particle diameter of the aforementioned R¹ was 5.7 μm and the mean primary particle diameter was 2.5 μm.

<3. Charge-Discharge Test of Non-Aqueous Electrolyte Secondary Battery>

A coin-type battery was produced using the aforementioned R¹. According to the discharge rate test carried out on the battery, the discharge capacities (mAh/g) at 0.2 C, 1 C, 5 C and 10 C were 140, 118, 88 and 34, respectively, and the discharge capacity maintenance rates (%) were 100, 84, 63 and 24, respectively, indicating inadequate discharge capacity maintenance rates.

### Comparative Example 2

<1. Production of Lithium Composite Metal Oxide>

The same procedure as Comparative Example 1 was carried out, with the exception of making the molar ratio of Ni:Mn:Co:Fe to be 0.47:0.29:0.19:0.05, to obtain a powdered lithium composite metal oxide R².

As a result of analyzing the composition of the aforementioned R², the molar ratio of Li:Ni:Mn:Co:Fe was 1.16:0.47:0.29:0.19:0.05, and the BET specific surface area was 0.3 m²/g. In addition, the mean particle diameter of the aforementioned R² was 6.0 and the mean primary particle diameter was 2.4

<2. Charge-Discharge Test of Non-Aqueous Electrolyte Secondary Battery>

A coin-type battery was produced using the aforementioned R². According to the discharge rate test carried out on the battery, and found that the discharge capacities (mAh/g) at 0.2 C, 1 C, 5 C and 10 C were 114, 90, 45 and 16, respectively, and the discharge capacity maintenance rates (%) were 100, 79, 40 and 14, respectively, indicating inadequate discharge capacity maintenance rates.

### Example 1

<1. Production of Transition Metal Composite Hydroxide>

Nickel sulfate hexahydrate as a nickel water-soluble salt, manganese sulfate monohydrate as a manganese water-soluble salt, cobalt sulfate heptahydrate as a cobalt water-soluble salt, and iron (II) sulfate heptahydrate as an iron water-soluble salt were respectively weighed out to a ratio of Ni:Mn:Co:Fe of 0.49:0.3:0.2:0.01, followed by dissolving them in pure water to obtain a transition metal aqueous solution containing Ni, Mn, Co and Fe. An aqueous potassium hydroxide solution as an alkaline metal aqueous solution was added to this transition metal aqueous solution, and co-precipitated to form a co-precipitate and obtain a co-precipitate slurry. The resulting slurry was then subjected to solid-liquid separation, and washed with distilled water to obtain a transition metal composite hydroxide. This was then dried at 150° C. to obtain a co-precipitate A¹.

<2. Production and Evaluation of Lithium Composite Metal Oxide>

The co-precipitate A¹, lithium carbonate and an inert dissolving agent in the form of potassium sulfate were mixed in a mortar to obtain a mixture. Next, the aforementioned mixture was placed in an alumina calcination container, calcined by holding it for 6 hours in an air atmosphere at 850° C. using an electric furnace, and cooled to room temperature to obtain a calcination product, followed by crushing, washing by decantation with distilled water, filtering and drying for 6 hours at 300° C. to obtain a powdered lithium composite metal oxide B¹.

When the composition of the aforementioned B¹ was analyzed, the molar ratio of Li:Ni:Mn:Co:Fe was 1.10:0.49:0.3:0.2:0.01, and the BET specific surface area was 4.0 m²/g. In addition, the mean particle diameter of the aforementioned B¹ was 0.2 μm, and the mean primary particle diameter was 0.2 μm.

<3. Charge-Discharge Test of Non-Aqueous Electrolyte Secondary Battery>

A coin-type battery was produced using the aforementioned B¹. According to the discharge rate test carried out on the battery, the discharge capacities (mAh/g) at 0.2 C, 1 C, 5 C and 10 C were 168, 159, 146 and 122, respectively, and the discharge capacity maintenance rates (%) were 100, 95, 87 and 73, respectively, indicating high discharge capacity maintenance rates.

### Example 2

<1. Production of Lithium Composite Metal Oxide>

The same procedure as Example 1 was carried out, with the exception of making the molar ratio of Ni:Mn:Co:Fe to be 0.47:0.29:0.19:0.05, to obtain a powdered lithium composite metal oxide B².

As a result of analyzing the composition of the aforementioned B², the molar ratio of Li:Ni:Mn:Co:Fe was 1.09:0.47:0.29:0.19:0.05, and the BET specific surface area was 4.8 m²/g. In addition, the mean particle diameter of the aforementioned B² was 0.2 μm, and the mean primary particle diameter was 0.2 μm.

<2. Charge-Discharge Test of Non-Aqueous Electrolyte Secondary Battery>

A coin-type battery was produced using the aforementioned B². According to the discharge rate test carried out on the battery, the discharge capacities (mAh/g) at 0.2 C, 1 C, 5 C and 10 C were 164, 153, 138 and 116, respectively, and the discharge capacity maintenance rates (%) were 100, 93, 84 and 71, respectively, indicating high discharge capacity maintenance rates.

### Example 3

<1. Production of Lithium Composite Metal Oxide>

The same procedure as Example 1 was carried out, with the exception of making the molar ratio of Ni:Mn:Co:Fe to be 0.59:0.2:0.2:0.01, to obtain a powdered lithium composite metal oxide B³.

As a result of analyzing the composition of the aforementioned B³, the molar ratio of Li:Ni:Mn:Co:Fe was 1.10:0.59:0.2:0.2:0.01, and the BET specific surface area was 3.6 m²/g. In addition, the mean particle diameter of the aforementioned B³ was 0.4 and the mean primary particle diameter was 0.3 μm.

<2. Charge-Discharge Test of Non-Aqueous Electrolyte Secondary Battery>

A coin-type battery was produced using the aforementioned B³. According to the discharge rate test carried out on the battery, the discharge capacities (mAh/g) at 0.2 C, 1 C, 5 C and 10 C were 174, 151, 139 and 111, respectively, and the discharge capacity maintenance rates (%) were 100, 87, 80 and 64, respectively, indicating high discharge capacity maintenance rates.

### Example 4

<1. Production of Lithium Composite Metal Oxide>

The same procedure as Example 1 was carried out, with the exception of making the molar ratio of Ni:Mn:Co:Fe to be 0.57:0.19:0.19:0.05, to obtain a powdered lithium composite metal oxide B⁴.

As a result of analyzing the composition of the aforementioned B⁴, the molar ratio of Li:Ni:Mn:Co:Fe was 1.07:0.57:0.19:0.19:0.05, and the BET specific surface area was 3.5 m²/g. In addition, the mean particle diameter of the aforementioned B⁴ was 0.4 μm, and the mean primary particle diameter was 0.2 μm.

<2. Charge-Discharge Test of Non-Aqueous Electrolyte Secondary Battery>

A coin-type battery was produced using the aforementioned B⁴. According to the discharge rate test carried out on the battery, the discharge capacities (mAh/g) at 0.2 C, 1 C, 5 C and 10 C were 168, 142, 135 and 116, respectively, and the discharge capacity maintenance rates (%) were 100, 85, 80 and 65, respectively, indicating high discharge capacity maintenance rates.

### Example 5

<1. Production of Lithium Composite Metal Oxide>

The same procedure as Example 1 was carried out, with the exception of making the molar ratio of Ni:Mn:Co:Fe to be 0.46:0.47:0.03:0.04, to obtain a powdered lithium composite metal oxide B⁵.

As a result of analyzing the composition of the aforementioned B⁵, the molar ratio of Li:Ni:Mn:Co:Fe was 1.09:0.46:0.47:0.03:0.04, and the BET specific surface area was 13.2 m²/g. In addition, the mean particle diameter of the aforementioned B⁵ was 0.3 μm, and the mean primary particle diameter was 0.2 μm.

<2. Charge-Discharge Test of Non-Aqueous Electrolyte Secondary Battery>

A coin-type battery was produced using the aforementioned B⁵. According to the discharge rate test carried out on the battery, the discharge capacities (mAh/g) at 0.2 C, 1 C, 5 C and 10 C were 147, 137, 121 and 106, respectively, and the discharge capacity maintenance rates (%) were 100, 93, 82 and 72, respectively, indicating high discharge capacity maintenance rates.

### Example 6

<1. Production of Lithium Composite Metal Oxide>

The same procedure as Example 1 was carried out, with the exception of making the molar ratio of Ni:Mn:Co:Fe to be 0.45:0.46:0.05:0.04, to obtain a powdered lithium composite metal oxide B⁶.

As a result of analyzing the composition of the aforementioned B⁶, the molar ratio of Li:Ni:Mn:Co:Fe was 1.07:0.45:0.46:0.05:0.04, and the BET specific surface area was 8.9 m²/g. In addition, the mean particle diameter of the aforementioned B⁶ was 0.2 μm, and the mean primary particle diameter was 0.2 μm.

<2. Charge-Discharge Test of Non-Aqueous Electrolyte Secondary Battery>

A coin-type battery was produced using the aforementioned B⁶. According to the discharge rate test carried out on the battery, the discharge capacities (mAh/g) at 0.2 C, 1 C, 5 C and 10 C were 149, 140, 124 and 103, respectively, and the discharge capacity maintenance rates (%) were 100, 94, 83 and 69, respectively, indicating high discharge capacity maintenance rates.

### Example 7

<1. Production of Lithium Composite Metal Oxide>

The same procedure as Example 1 was carried out, with the exception of making the molar ratio of Ni:Mn:Co:Fe to be 0.42:0.43:0.10:0.05, to obtain a powdered lithium composite metal oxide B⁷.

As a result of analyzing the composition of the aforementioned B⁷, the molar ratio of Li:Ni:Mn:Co:Fe was 1.06:0.42:0.43:0.10:0.05, and the BET specific surface area was 9.8 m²/g. In addition, the mean particle diameter of the aforementioned B⁷ was 0.2 μm, and the mean primary particle diameter was 0.2 μm.

<2. Charge-Discharge Test of Non-Aqueous Electrolyte Secondary Battery>

A coin-type battery was produced using the aforementioned B⁷. According to the discharge rate test carried out on the battery, the discharge capacities (mAh/g) at 0.2 C, 1 C, 5 C and 10 C were 154, 146, 132 and 118, respectively, and the discharge capacity maintenance rates (%) were 100, 95, 86 and 77, respectively, indicating high discharge capacity maintenance rates.

### Example 8

<1. Production of Lithium Composite Metal Oxide>The same procedure as Example 1 was carried out, with the exception of making the molar ratio of Ni:Mn:Co:Fe to be 0.43:0.44:0.10:0.03 and changing the calcination temperature to 870° C., to obtain a powdered lithium composite metal oxide B8.

As a result of analyzing the composition of the aforementioned B⁸, the molar ratio of Li:Ni:Mn:Co:Fe was 1.15:0.43:0.44:0.10:0.03, and the BET specific surface area was 8.7 m²/g. In addition, the mean particle diameter of the aforementioned B⁸ was 0.4 μm, and the mean primary particle diameter was 0.2 μm.

<2. Charge-Discharge Test of Non-Aqueous Electrolyte Secondary Battery>

A coin-type battery was produced using the aforementioned B⁸. According to the discharge rate test carried out on the battery, the discharge capacities (mAh/g) at 0.2 C, 1 C, 5 C and 10 C were 156, 149, 136 and 121, respectively, and the discharge capacity maintenance rates (%) were 100, 96, 87 and 78, respectively, indicating high discharge capacity maintenance rates.

### Example 9

<1. Production of Lithium Composite Metal Oxide>

The same procedure as Example 1 was carried out, with the exception of making the molar ratio of Ni:Mn:Co:Fe to be 0.40:0.42:0.15:0.03, to obtain a powdered lithium composite metal oxide B⁹.

As a result of analyzing the composition of the aforementioned B⁹, the molar ratio of Li:Ni:Mn:Co:Fe was 1.11:0.40:0.42:0.15:0.03, and the BET specific surface area was 7.6 m²/g. In addition, the mean particle diameter of the aforementioned B⁹ was 0.5 μm, and the mean primary particle diameter was 0.3 μm.

<2. Charge-Discharge Test of Non-Aqueous Electrolyte Secondary Battery>

A coin-type battery was produced using the aforementioned B⁹. According to the discharge rate test carried out on the battery, the discharge capacities (mAh/g) at 0.2 C, 1 C, 5 C and 10 C were 156, 150, 140 and 114, respectively, and the discharge capacity maintenance rates (%) were 100, 96, 90 and 73, respectively, indicating high discharge capacity maintenance rates.

### Comparative Example 3

<1. Production of Lithium Composite Metal Oxide>

The same procedure as Comparative Example 1 was carried out, with the exception of making the molar ratio of Ni:Mn:Co:Fe to be 0.47:0.48:0.0:0.05, to obtain a powdered lithium composite metal oxide R³.

As a result of analyzing the composition of the aforementioned R³, the molar ratio of Li:Ni:Mn:Co:Fe was 1.07:0.47:0.48:0.0:0.05, and the BET specific surface area was 0.7 m²/g. In addition, the mean particle diameter of the aforementioned R³ was 2.5 μm, and the mean primary particle diameter was 2.0 μm.

<2. Charge-Discharge Test of Non-Aqueous Electrolyte Secondary Battery>

A coin-type battery was produced using the aforementioned R³. According to the discharge rate test carried out on the battery, the discharge capacities (mAh/g) at 0.2 C, 1 C, 5 C and 10 C were 110, 70, 33 and 18, respectively, and the discharge capacity maintenance rates (%) were 100, 64, 30 and 16, respectively, indicating inadequate discharge capacity maintenance rates.

### Comparative Example 4

<1. Production of Lithium Composite Metal Oxide>

The same procedure as Example 7 was carried out, with the exception of changing the calcination temperature of the mixture to 950° C., to obtain a powdered lithium composite metal oxide R⁴.

As a result of analyzing the composition of the aforementioned R⁴, the molar ratio of Li:Ni:Mn:Co:Fe was 1.06:0.42:0.43:0.1:0.05, and the BET specific surface area was 2.5 m²/g. In addition, the mean particle diameter of the aforementioned R⁴ was 1.5 μm, and the mean primary particle diameter was 0.8 μm.

<2. Charge-Discharge Test of Non-Aqueous Electrolyte Secondary Battery>

A coin-type battery was produced using the aforementioned R⁴. According to the discharge rate test carried out on the battery, the discharge capacities (mAh/g) at 0.2 C, 1 C, 5 C and 10 C were 148, 125, 104 and 63, respectively, and the discharge capacity maintenance rates (%) were 100, 84, 70 and 43, respectively, indicating inadequate discharge capacity maintenance rates.

### Comparative Example 5

<1. Production of Lithium Composite Metal Oxide>

Lithium hydroxide monohydrate, nickel (II) hydroxide, manganese (II) oxide, cobalt (II) hydroxide and iron (III) hydroxide were respectively weighed out to a ratio of Li:Ni:Mn:Co:Fe of 1.0:0.95:0.005:0.04:0.005, followed by mixing in a mortar and then respectively heat-treating for 20 hours at 750° C. in a dry air atmosphere and crushing with a mortar to obtain a powdered lithium composite metal oxide R⁵.

When the composition of the aforementioned R⁵ was analyzed, the molar ratio of Li:Ni:Mn:Co:Fe was 1.02:0.95:0.005:0.04:0.005, and the BET specific surface area was 2.2 m²/g. In addition, the mean particle diameter of the aforementioned R⁵ was 1.2 μm, and the mean primary particle diameter was 0.3 μm.

<2. Charge-Discharge Test of Non-Aqueous Electrolyte Secondary Battery>

A coin-type battery was produced using the aforementioned R⁵. According to the discharge rate test carried out on the battery, the discharge capacities (mAh/g) at 0.2 C, 1 C, 5 C and 10 C were 165, 135, 94 and 40, respectively, and the discharge capacity maintenance rates (%) were 100, 82, 57 and 24, respectively, indicating inadequate discharge capacity maintenance rates.

### Comparative Example 6

<1. Production of Lithium Composite Metal Oxide>

The same procedure as Example 1 was carried out, with the exception of making the molar ratio of Ni:Mn:Co:Fe to be 0.47:0.48:0.0:0.05 and changing the calcination temperature to 750° C., to obtain a powdered lithium composite metal oxide R⁶.

As a result of analyzing the composition of the aforementioned R⁶, the molar ratio of Li:Ni:Mn:Co:Fe was 1.12:0.47:0.48:0.0:0.05, and the BET specific surface area was 16.2 m²/g. In addition, the mean particle diameter of the aforementioned R⁶ was 0.2 μm, and the mean primary particle diameter was 0.2 μm.

<2. Charge-Discharge Test of Non-Aqueous Electrolyte Secondary Battery>

A coin-type battery was produced using the aforementioned R⁶. According to a discharge rate test carried out on the battery, the discharge capacities (mAh/g) at 0.2 C, 1 C, 5 C and 10 C were 143, 120, 103 and 53, respectively, and the discharge capacity maintenance rates (%) were 100, 84, 72 and 37, respectively, indicating inadequate discharge capacity maintenance rates.

### Summary

Evaluation results for the examples and comparative examples are summarized in the following Table 1.

TABLE 1

| | | Comp. | Comp. | | | | | | |
|---|---|---|---|---|---|---|---|---|---|
| | | Ex. 1 | Ex. 2 | Ex. 1 | Ex. 2 | Ex. 3 | Ex. 4 | Ex. 5 | Ex. 6 |
| | | (R1) | (R2) | (B1) | (B2) | (B3) | (B4) | (B5) | (B6) |
| Lithium | Li | 1.13 | 1.16 | 1.10 | 1.09 | 1.10 | 1.07 | 1.09 | 1.07 |
| composite | Ni | 0.49 | 0.47 | 0.49 | 0.47 | 0.59 | 0.57 | 0.46 | 0.45 |
| metal oxide | Mn | 0.30 | 0.29 | 0.30 | 0.29 | 0.20 | 0.19 | 0.47 | 0.46 |
| composition | Co | 0.20 | 0.19 | 0.20 | 0.19 | 0.20 | 0.19 | 0.03 | 0.05 |
| | Fe | 0.01 | 0.05 | 0.01 | 0.05 | 0.01 | 0.05 | 0.04 | 0.04 |
| BET (m²/g) | | 0.2 | 0.3 | 4.0 | 4.8 | 3.6 | 3.5 | 13.2 | 8.9 |
| Mean particle | | 5.7 | 6.0 | 0.2 | 0.2 | 0.4 | 0.4 | 0.3 | 0.2 |
| diam. (μm) | Primary | 2.5 | 2.4 | 0.2 | 0.2 | 0.3 | 0.2 | 0.2 | 0.2 |
| Discharge | 0.2 C | 140 | 114 | 168 | 164 | 174 | 168 | 147 | 149 |
| capacity | 1 C | 118 | 90 | 159 | 153 | 151 | 142 | 137 | 140 |
| (mAh/g) | 5 C | 88 | 45 | 146 | 138 | 139 | 135 | 121 | 124 |
| | 10 C | 34 | 16 | 122 | 116 | 111 | 116 | 106 | 103 |
| Discharge | 0.2 C | 100 | 100 | 100 | 100 | 100 | 100 | 100 | 100 |
| capacity | 1 C | 84 | 79 | 95 | 93 | 87 | 85 | 93 | 94 |
| maintenance | 5 C | 63 | 40 | 87 | 84 | 80 | 80 | 82 | 83 |
| rate (%) | 10 C | 24 | 14 | 73 | 71 | 64 | 65 | 72 | 69 |

| | | | | | Comp. | Comp. | Comp. | Comp. |
|---|---|---|---|---|---|---|---|---|
| | | Ex. 7 | Ex. 8 | Ex. 9 | Ex. 3 | Ex. 4 | Ex. 5 | Ex. 6 |
| | | (B7 | (B8) | (B9) | (R3) | (R4) | (R5) | (R6) |
| Lithium | Li | 1.06 | 1.15 | 1.11 | 1.07 | 1.06 | 1.02 | 1.12 |
| composite | Ni | 0.42 | 0.43 | 0.40 | 0.47 | 0.42 | 0.95 | 0.47 |
| metal oxide | Mn | 0.43 | 0.44 | 0.42 | 0.48 | 0.43 | 0.005 | 0.48 |
| composition | Co | 0.10 | 0.10 | 0.15 | 0.00 | 0.10 | 0.04 | 0.00 |
| | Fe | 0.05 | 0.03 | 0.03 | 0.05 | 0.05 | 0.005 | 0.05 |
| BET (m²/g) | | 9.8 | 8.7 | 7.6 | 0.7 | 2.5 | 2.2 | 16.2 |
| Mean particle | | 0.2 | 0.4 | 0.5 | 2.5 | 1.5 | 1.2 | 0.2 |
| diam. (μm) | Primary | 0.2 | 0.2 | 0.3 | 2.0 | 0.8 | 0.3 | 0.2 |
| Discharge | 0.2 C | 154 | 156 | 156 | 110 | 148 | 165 | 143 |
| capacity | 1 C | 146 | 149 | 150 | 70 | 125 | 135 | 120 |
| (mAh/g) | 5 C | 132 | 136 | 140 | 33 | 104 | 94 | 103 |
| | 10 C | 118 | 121 | 114 | 18 | 63 | 40 | 53 |
| Discharge | 0.2 C | 100 | 100 | 100 | 100 | 100 | 100 | 100 |
| capacity | 1 C | 95 | 96 | 96 | 64 | 84 | 82 | 84 |
| maintenance | 5 C | 86 | 87 | 90 | 30 | 70 | 57 | 72 |
| rate (%) | 10 C | 77 | 78 | 73 | 16 | 43 | 24 | 37 |

### Production Example 1

### Production of Laminated Film

(1) Production of Coating Liquid

After dissolving 272.7 g of calcium chloride in 4200 g of NMP, 132.9 g of paraphenylene diamine were added thereto and completely dissolved. 243.3 g of terephthalic acid dichloride were then gradually added to the resulting solution and polymerized to obtain a para-aramid, followed by further diluting with NMP to obtain a para-aramid solution (A) having a concentration of 2.0% by weight. 2 g of alumina powder (a) (Nippon Aerosil Co., Ltd., Alumina C, mean particle diameter: 0.02 μm) and 2 g of alumina powder (b) (Sumitomo Chemical Co., Ltd., Sumicorondum AA03, mean particle diameter: 0.3 μm) were added as a total of 4 g of filler to 100 g of the resulting para-aramid solution and mixed, followed by treating three times with a Nanomizer, filtering through a 1000 mesh metal screen and degassing under reduced pressure to obtain a slurry-like coating liquid (B). The weight ratio of the alumina powder (filler) to the total weight of the para-aramid and alumina powder was 67% by weight.

(2) Production and Evaluation of Laminated Film

A polyethylene porous film (film thickness: 12 μm, air permeability: 140 seconds/100 cc, mean pore diameter: 0.1 μm, porosity: 50%) was used as a porous film. The aforementioned polyethylene porous film was immobilized on a PET film having a thickness of 100 μm, and the slurry-like coating liquid (B) was applied onto the aforementioned porous film using a bar coater manufactured by Tester Sangyo Co., Ltd. With the aforementioned coated porous film still being integrated on the PET film, the coated porous film was immersed in water as a poor solvent, and after depositing the para-aramid porous film (heat-resistant porous layer), the solvent was dried to obtain a laminated film 1 composed of a heat-resistant porous layer and porous film.

The thickness of the laminated film 1 was 16 μm, and the thickness of para-aramid porous film (heat-resistant porous layer) was 4 μm. The air permeability of the laminated film 1 was 180 seconds/100 cc, and the porosity was 50%. When a cross-section of the heat-resistant porous layer of the laminated film 1 was observed with a scanning electron microscope (SEM), comparatively small micropores of about 0.03 μm to 0.06 μm and comparatively large micropores of about 0.1 μm to 1 μm were found. Furthermore, the laminated film was evaluated in the manner described below.

<Evaluation of Laminated Film>

(A) Measurement of Thickness

The thickness, air permeability and porosity of the laminated film were determined in the manner described below.

(A) Measurement of Thickness

The thickness of the laminated film and the thickness of the porous film were measured according to a JIS standard (K7130-1992). In addition, a value determined by subtracting the thickness of the porous film from the thickness of the laminated film was used as the thickness of the heat-resistant porous layer.

(B) Measurement of Air Permeability by Gurley Method The air permeability of the laminated film was measured with a Gurley densometer equipped with a digital timer manufactured by Yasuda Seiki Seisakusho Ltd. based on JIS P8117.

(C) Porosity

A sample of the resulting laminated film was cut out into the shape of a square measuring 10 cm on a side followed by measurement of the weight W (g) and thickness D (cm) thereof. The weight (Wi (g)) (where, i=1 to n) of each layer in the sample was determined, and the volume of each layer was determined from Wi and the true specific gravity (true specific gravity i (g/cm³)) of each layer, followed by determination of porosity (vol %) according to the following equation.

Porosity (vol %)=100×{1−(W1/true specific gravity 1+W2/true specific gravity 2 . . . +Wn/true specific gravity n)/(10×10×D)}

1. A lithium composite metal oxide comprising Ni, Mn, Co and Fe, wherein BET specific surface area is 3 m²/g to 15 m²/g.

2. The lithium composite metal oxide according to claim 1, wherein the mean particle diameter as measured by laser diffraction and scattering is 0.1 μm to less than 1 μm.

3. The lithium composite metal oxide according to claim 1, wherein the mean primary particle diameter is 0.05 μm to 0.4 μm.

4. The lithium composite metal oxide according to claim 1 represented by the following formula (A):
Liₐ(Ni_{1-x-y-z}MnₓCo_{y}Fe_{z})O₂ (A)
wherein,
0.9≦a≦1.3,
0.3≦x≦0.6,
0.01≦y≦0.4,
0.01≦z≦0.1, and
0.3≦x+y+z≦0.7.

5. A method for producing a lithium composite metal oxide comprising the following steps (1), (2) and (3) in that order:
(1) obtaining a co-precipitate slurry by bringing a raw material aqueous solution containing Ni ions, Mn ions, Co ions, Fe ions and sulfate ions into contact with alkali to form a co-precipitate,
(2) obtaining the co-precipitate from the co-precipitate slurry, and
(3) obtaining a lithium composite metal oxide by mixing the co-precipitate and a lithium compound, and calcining the resulting mixture by holding at a temperature of 650° C. to 950° C.

6. The production method according to claim 5, wherein the step (2) is the following step (2′):
(2′) obtaining the co-precipitate by subjecting the co-precipitate slurry to solid- liquid separation followed by washing and drying.

7. The production method according to claim 5, wherein the raw material aqueous solution is an aqueous solution obtained by dissolving a sulfate of Ni, a sulfate of Mn, a sulfate of Co and a sulfate of Fe in water.

8. The production method according to claim 7, wherein the sulfate of Fe is a sulfate of divalent Fe.

9. A lithium composite metal oxide obtained by the production method according to claim 5.

10. A positive electrode active material for a non-aqueous electrolyte secondary battery, which material is mainly composed of the lithium composite metal oxide according to claim 1.

11. A positive electrode for a non-aqueous electrolyte secondary battery, the electrode having the positive electrode active material for a non-aqueous electrolyte secondary battery according to claim 10.

12. A non-aqueous electrolyte secondary battery having the positive electrode for a non-aqueous electrolyte secondary battery according to claim 11.

13. The non-aqueous electrolyte secondary battery according to claim 12 further having a separator.

14. The non-aqueous electrolyte secondary battery according to claim 13, wherein the separator is a separator composed of a laminated film obtained by laminating a heat- resistant porous layer and a porous film.
